(19) United States
(12) Patent Application Publication
(10) Pub. No.: US 2008/0176558 A1
(43) Pub. Date: Jul. 24, 2008

(54) SYSTEM AND METHOD FOR PROMPTING AN INCOMING CALL

(75) Inventors: Bing Li, Shenzhen City (CN); Xiao-Guang Li, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/949,052

(22) Filed: Dec. 3, 2007

(30) Foreign Application Priority Data
Jan. 23, 2007 (CN) 200710200099.X

(51) Int. Cl. H04Q 7/32

(52) U.S. Cl. 455/426.1

(57) ABSTRACT

The present invention relates to a communication system. The communication system includes a handheld communication device embedding a primary communication module therein, and a secondary communication apparatus. The primary communication module is configured for communicating with the secondary communication apparatus in a predetermined area. When a user of the handheld communication device forgets the handheld communication device halfway, an incoming call of ring tones of the handheld communication device don't annoy and affect others around. The present invention also provides an incoming call prompting method for supporting the aforementioned communication system.

### BACKGROUND OF THE INVENTION

1. Field of the Invention

The present invention relates to a communication system, and more particularly, to a handheld communication device and a secondary communication apparatus.

2. General Background

Handheld communication devices (e.g., mobile phones) generally provide a plurality of notification settings from a menu of sound settings, such as a ring tone, a vibration, and a combination of a ring tone and a vibration. When receiving an incoming call, a mobile phone will alert a user by the notification settings predetermined or set by the user of the mobile phone. Generally, the mobile phone is frequently set to ring. Accordingly, when the user hears the ringing from the mobile phone, the user may answer the incoming call. If the user is beyond the audible range of the ringing of the mobile phone, the mobile phone will ring repeatedly. If no one answers the incoming call, the mobile phone will stop ringing after a period of time (e.g., about fifty seconds), which may be a default time or set by the user.

In some public places that require quiet, such as offices, classrooms, etc, calls that go unanswered may become an audible ringing noise, and annoy nearby people.

Accordingly, what is needed in the art is a system that overcomes the deficiencies of the prior art.

### SUMMARY OF THE INVENTION

A communication system is provided. The communication system includes a handheld communication device and a secondary communication apparatus, wherein the handheld communication device includes a detecting unit for detecting an incoming call; a primary communication module, for communicating with the secondary communication apparatus in a predetermined area; a CPU, for invoking the primary communication module to send a search signal to the secondary communication apparatus when the detecting unit detects the incoming call, and for deactivating a predetermined alert type of the handheld communication device when the primary communication module receives a response signal from the secondary communication apparatus.

An incoming call prompting method adapted for a handheld communication device is provided. Wherein the handheld communication device includes a primary communication module for communicating with a secondary communication apparatus in a predetermined area, the method includes the steps of: (a) detecting an incoming call; (b) sending a search signal to the secondary communication apparatus; (c) receiving a response signal from the secondary communication apparatus; and (d) deactivating a predetermined alert type of the handheld communication device.

Other advantages and novel features will be drawn from the following detailed description with reference to the attached drawings.

### BRIEF DESCRIPTION OF THE DRAWINGS

The components in the drawings are not necessarily drawn to measuring scale, the emphasis instead being placed upon clearly illustrating the principles of the communication system. Moreover, in the drawings, like reference numerals designate corresponding parts throughout the several views.

FIG. 1 is a schematic diagram of a hardware infrastructure of a communication system for prompting an incoming call in accordance with a preferred embodiment of the present invention;

FIG. 2 is a block diagram of a hardware infrastructure of the handheld communication device of FIG. 1;

FIG. 3 is a block diagram of a hardware infrastructure of the secondary communication apparatus of FIG. 1; and

FIG. 4 is a flow chart illustrating a preferred incoming call prompting method which is performed by the communication system of FIG. 1.

### DETAILED DESCRIPTION OF THE INVENTION

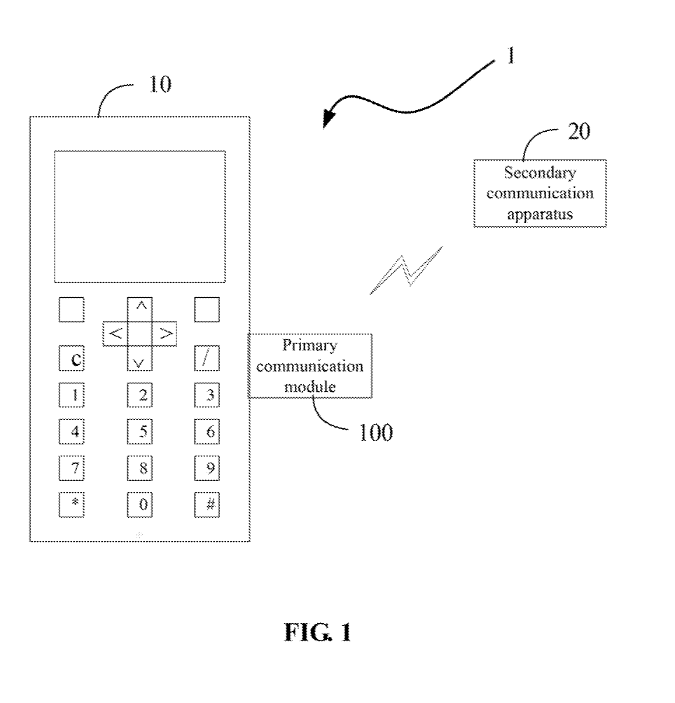

FIG. 1 is a schematic diagram of a hardware infrastructure of a communication system for prompting an incoming call in accordance with a preferred embodiment of the present invention. The communication system 1 includes a handheld communication device 10 (hereinafter “the device”) and a secondary communication apparatus 20 (hereinafter “the apparatus”). The device 10 is a communication terminal such as a mobile phone, a PDA, etc. The apparatus 20 is a wireless accessory of the device 10, and is carried by owner of the device 10; for example, the apparatus 20 can be worn on the wrist of the owner, or pinned on the owner's clothes. The device 10 includes a primary communication module 100. The primary communication module 100 is configured for communicating with the apparatus 20 in a predetermined area. The predetermined area may be a range where the owner of the device 10 can successfully answer an incoming call from the device 10, e.g. ten meters between the device 10 and the apparatus 20. The primary communication module 100 and the apparatus 20 may be Bluetooth modules or radio frequency identification (RFID) modules.

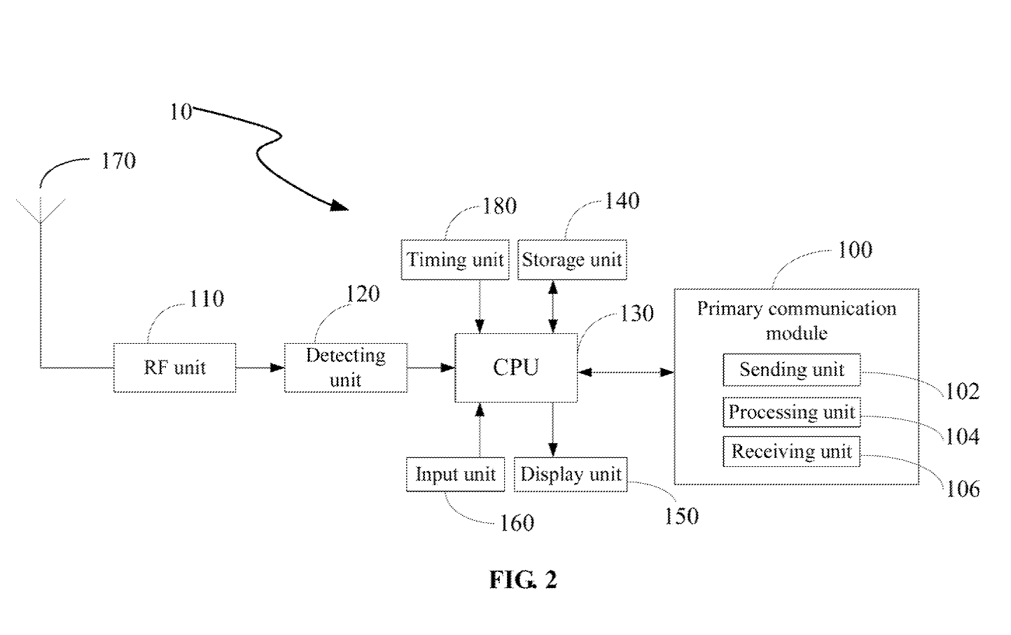

FIG. 2 is a block diagram of a hardware infrastructure of the device 10. The device 10 includes an antenna 170, a radio frequency (RF) unit 110, a detecting unit 120, a central processing unit (CPU) 130, a storage unit 140, a display unit 150 (e.g., liquid crystal display (LCD)), a primary communication module 100, an input unit 160, and a timing unit 180. The input unit 160 typically includes a plurality of input keys. The antenna 170 and the RF unit 110 are configured for communicating with an external wireless communication network (not shown). The wireless communication network may be a global system for mobile communication (GSM), a code division multiple access (CDMA), a general packet radio service (GPRS), or any other wireless network. The detecting unit 120 is configured for detecting the incoming call via the antenna 170 and the RF unit 110.

The CPU 130, electrically coupled to the detecting unit 120, is configured for controlling the primary communication module 100 to process the incoming call from the detecting unit 120. When the detecting unit 120 detects the incoming call, the CPU 130 invokes the primary communication module 100 to send a search signal for detecting whether the apparatus 20 is in the predetermined area. If the primary communication module 100 does not receive a response signal from the apparatus 20, meaning a distance between the device 10 and the apparatus 20 exceeds the predetermined area or the apparatus 20 is turned off, the CPU 130 activates a predetermined alert type. If the primary communication module 100 receives the response signal from the apparatus 20 in the predetermined area, the CPU 130 deactivates the predetermined alert type. The predetermined alert type of the device 10 may be a ring tone, a vibration, or a combination of a ring tone and a vibration. When receiving the search signal from the device 10, the apparatus 20 prompts the owner that the device 10 has the incoming call through a predetermined manner, such as a flash, a vibration, etc.

The timing unit 180 is configured for measuring time. When the detecting unit 120 detects the incoming call, the timing unit 180 starts to measure time. If the CPU 130 receives an answer signal for the incoming call generated from the input unit 160, the timing unit 180 stops measuring time. If the CPU 130 does not receive the answer signal for the incoming call and the measured time exceeds a predetermined time (e.g., about fifty seconds), the timing unit 180 stops measuring time. The CPU 130 disconnects a communication with the incoming call, and establishes a missed call record. The missed call record includes a telephone number or a name of a caller of the missed call, a date of the missed call, and a time of the missed call. The storage unit 140 stores the missed call record. The display unit 150, electrically coupled to the CPU 130, is configured for displaying information under controls of the CPU 130.

The primary communication module 100 includes a sending unit 102, a processing unit 104, and a receiving unit 106. When the detecting unit 120 detects the incoming call from the wireless communication network, the CPU 130 controls the processing unit 104 of the primary communication module 100 to invoke the sending unit 102 to send the search signal to the apparatus 20. The processing unit 104 detects whether the receiving unit 106 receives the response signal from the apparatus 20. If the receiving unit 106 receives the response signal, the processing unit 104 sends a first signal to the CPU 130 indicative of receiving the response signal. The CPU 130 deactivates the predetermined alert type in response to the first signal. If the receiving unit 106 does not receive the response signal from the apparatus 20, the processing unit 104 sends a second signal to the CPU 130 indicative of not receiving the response signal. The CPU 130 activates the predetermined alert type in response to the second signal.

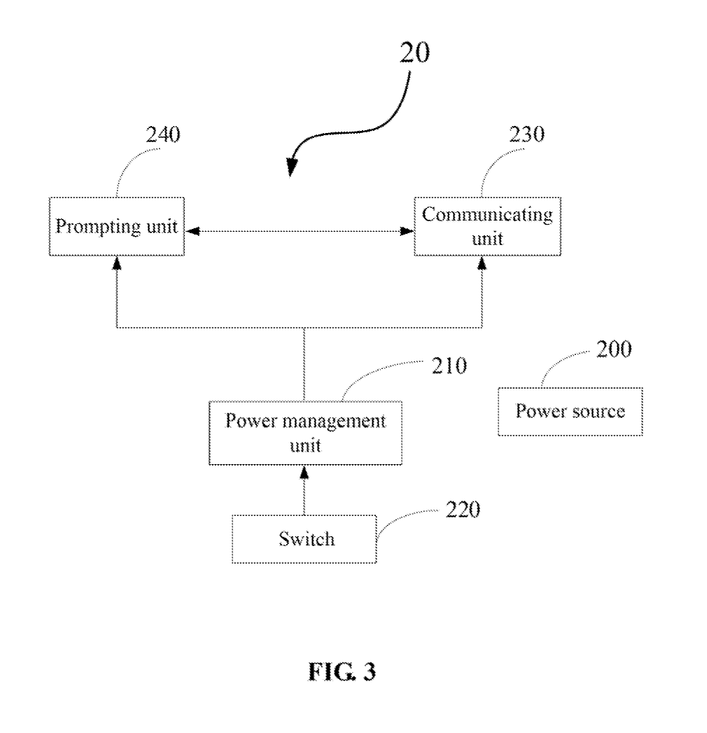

FIG. 3 is a block diagram of a hardware infrastructure of the secondary communication apparatus 20. The apparatus 20 includes a power source 200, a power management unit 210, a switch 220, a communicating unit 230, and a prompting unit 240. The power source 200 is configured for supplying power to all units of the apparatus 20. The power management unit 210 is configured for controlling the power source 200 and connecting the power source 200 to the switch 220. When the switch 220 is not actuated, the power management unit 210 controls the power source 200 to stop supplying power, meaning the apparatus 20 is turned off. When the switch 220 is actuated, the power management unit 210 controls the power source 200 to supply power to the apparatus 20 and the apparatus 20 receives the search signal from the device 10 in the predetermined area.

The communicating unit 230 is configured for receiving the search signal from the primary communication module 100 and sending the response signal to the primary communication module 100. When receiving the search signal from the primary communication module 100, the communicating unit 230 sends the response signal to the primary communication module 100 in the predetermined area. The prompting unit 240, electrically coupled to the communicating unit 230, is configured for prompting the owner that the device 10 has the incoming call through the predetermined manner after the communicating unit 230 receives the search signal.

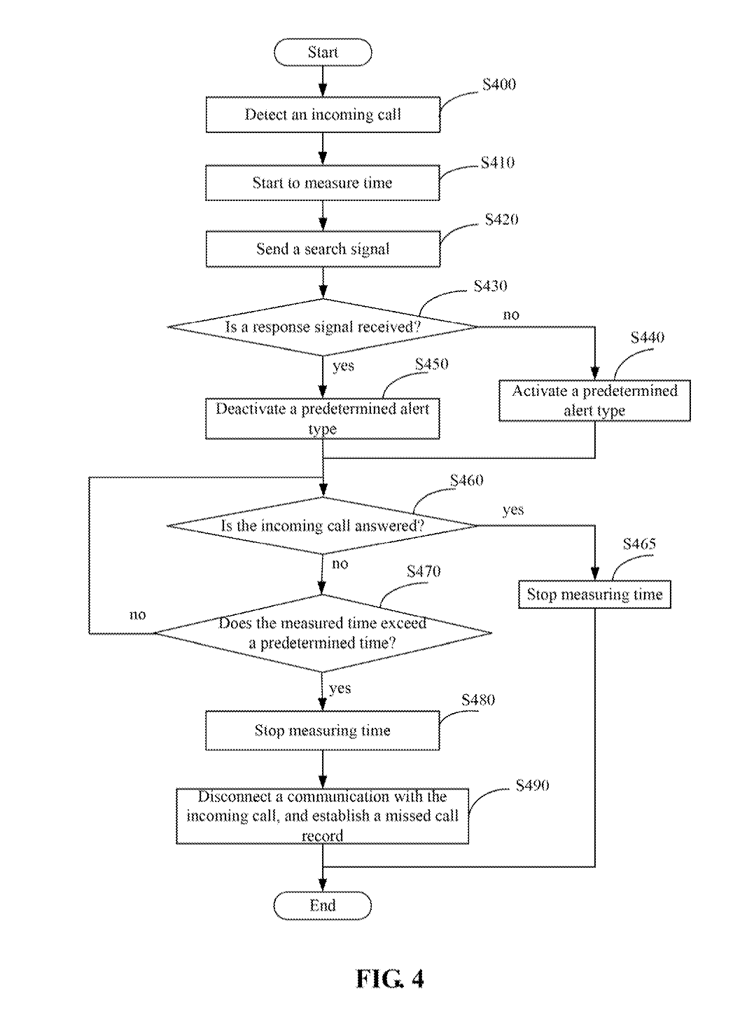

FIG. 4 is a flow chart illustrating a preferred incoming call prompting method which is performed by the communication system 1. In step S400, the device 10 is in an idle state, meaning the device 10 is turned on but is not currently being used by the owner of the device 10, and the detecting unit 120 detects the incoming call. In step S410, the CPU 130 invokes the timing unit 180 to start to measure time. In step S420, the sending unit 102 of the primary communication module 100 sends the search signal to the apparatus 20. In step S430, the primary communication module 100 detects whether the response signal from the apparatus 20 is received. If the primary communication module 100 does not receive the response signal from the apparatus 20, in step S440, and the CPU 130 activates a predetermined alert type of the device 10.

If the primary communication module 100 receives the response signal, in step S450, the CPU 130 deactivates the predetermined alert type. In step S460, the CPU 130 determines whether it receives the answer signal for the incoming call generated from the input unit 160. If receiving the answer signal, in step S465, the CPU 130 invokes the timing unit 180 to stop measuring time. If the CPU 130 does not receive the answer signal, in step S470, the CPU 130 determines whether the measured time exceeds the predetermined time. If the measured time does not exceed the predetermined time, the flow returns to S460. If the measured time exceeds the predetermined time, in step S480, the CPU 130 invokes the timing unit 180 to stop measuring time. In step S490, the CPU 130 disconnects a communication with the incoming call, and established the missed call record.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A communication system comprising:
a handheld communication device; and
a secondary communication apparatus;
wherein the handheld communication device, comprising:
a detecting unit for detecting an incoming call;
a primary communication module, for communicating with the secondary communication apparatus in a predetermined area;
a CPU, for invoking the primary communication module to send a search signal to the secondary communication apparatus when the detecting unit detects the incoming call, and for deactivating a predetermined alert type of the handheld communication device when the primary communication module receives a response signal from the secondary communication apparatus.

2. The communication system as recited in claim 1, wherein the secondary communication apparatus is a wireless accessory of the handheld communication device, and is carried by the owner of the handheld communication device.

3. The communication system as recited in claim 1, wherein the primary communication module comprises:
a sending unit for sending the search signal to the secondary communication apparatus;
a receiving unit for receiving the response signal from the secondary communication apparatus; and
a processing unit for invoking the sending unit to send the search signal when the detecting unit detects the incoming call, and for sending a signal to the CPU indicative of whether or not the receiving unit receives the response signal from the secondary communication apparatus.

4. The communication system as recited in claim 3, wherein when the receiving unit receives the response signal, the processing unit sends a first signal indicative of receiving the response signal; and when the receiving unit does not receive the response signal, the processing unit sends a second signal indicative of not receiving the response signal.

5. The communication system as recited in claim 1, wherein when the primary communication module does not receive the response signal from the secondary communication apparatus, the CPU activates the predetermined alert type.

6. The communication system as recited in claim 1, wherein the primary communication module and the secondary communication apparatus are Bluetooth modules.

7. The communication system as recited in claim 1, wherein the primary communication module and the secondary communication apparatus are RFID modules.

8. An incoming call prompting method adapted for a handheld communication device, wherein the handheld communication device comprising a primary communication module for communicating with a secondary communication apparatus in a predetermined area, the method comprising:
detecting an incoming call;
sending a search signal to the secondary communication apparatus;
receiving a response signal from the secondary communication apparatus; and
deactivating a predetermined alert type of the handheld communication device.

9. The incoming call prompting method as recited in claim 8, further comprising:
activating the predetermined alert type, when the primary communication module does not receive the response signal from the secondary communication apparatus.
